(19) United States
(12) Patent Application Publication
(10) Pub. No.: US 2006/0133318 A1
(43) Pub. Date: Jun. 22, 2006

(54) System and method for monitoring quality of service in a broadband wireless network

(76) Inventors: Jae-Dong Jung, Yongin-si (KR); Seong-Joon Jeon, Yongin-si (KR)

Correspondence Address: Robert E. Bushnell, Suite 300, 1522 K Street, N.W., Washington, DC, 20005-1202, US

(21) Appl. No.: 11/280,294

(22) Filed: Nov. 17, 2005

(30) Foreign Application Priority Data
Dec. 20, 2004 (KR) 2004-108965

(51) Int. Cl. H04Q 7/00

(52) U.S. Cl. 370/331; 370/252

(57) ABSTRACT

A system and a method for monitoring Quality of Service (QoS) in a broadband wireless network use previously designated QoS to continuously provide stable QoS to a wireless terminal in the broadband wireless network when the wireless terminal is handed off from one base station to another. In the system for monitoring QoS, a monitoring server receives and monitors QoS information in real time from base stations having synchronized time information. When a wireless terminal in a service zone of a first base station requests to be handed off to a second base station, the monitoring server determines a QoS level according to QoS information of the second base station, and then transmits the QoS level simultaneously to the first and second base stations.

### CLAIM OF PRIORITY

This application makes reference to, incorporates the same herein, and claims all benefits accruing under 35 U.S.C. § 119 from an application for SYSTEM AND METHOD FOR MONITORING QUALITY OF SERVICE IN A BROADBAND WIRELESS NETWORK earlier filed in the Korean Intellectual Property Office on 20 Dec. 2004, and there duly assigned Serial No. 10-2004-0108965.

### BACKGROUND OF THE INVENTION

1. Technical Field

The present invention relates to a system and a method for monitoring Quality of Service (QoS) in a broadband wireless network, the system and method being adapted to minimize QoS authentication procedures in a handoff process for a wireless terminal in order to provide optimum QoS.

2. Related Art

Technologies associated with mobility are essential in the mobile Internet based upon Institute of Electrical and Electronic Engineers (IEEE) 802.16 standards. In these technologies, research and development have been performed incessantly to develop a fast handoff technique for saving delay time in handoff, and to develop a technique for maintaining more stable connection during handoff. Various endeavors have been made in traffic management technologies to stably maintain service quality in fixed networks. However, it is difficult for mobile Internet systems to continuously support Quality of Service (QoS) for wireless terminals which roam through various cell zones of different cell environments. Therefore, it is required to maintain QoS in mobile networks as in existing wired networks.

### SUMMARY OF THE INVENTION

It is, therefore, an object of the present invention to provide a system and a method for monitoring QoS in a broadband wireless network, which system and method are adapted to monitor QoS information of base stations, and to previously designate wireless terminals with QoS levels in the broadband wireless network in order to minimize QoS authentication procedures, thereby ensuring optimum QoS without time delay when a wireless terminal is handed off.

According to an aspect of the invention for realizing the above objects, there is provided a system for monitoring QoS in a broadband wireless network, the system comprising a monitoring server adapted to perform the following functions: receive and monitor QoS information in real time from base stations having synchronized time information; when a wireless terminal in a service zone of a first base station requests to be handed off to a second base station, determine a QoS level according to a QoS information of the second base station; and transmit the QoS level simultaneously to the first and second base stations.

The monitoring server is adapted to examine the QoS information of the second base station, and if a service level the same as a QoS information of the first base station is determined to be not available for the wireless terminal, determine a QoS level available for the wireless terminal.

The wireless terminal is provided with a service according to the QoS level determined by the monitoring server when hand off to a cell zone of the second base station occurs.

The monitoring server may comprise: a QoS memory for storing the QoS information received in real time from the base stations having synchronized time information; a control unit for examining the QoS information of the second base station stored in the QoS memory in response to a handoff request from the first base station to determine whether or not a service level the same as the QoS information of the first base station is available; and a QoS level determiner for determining a QoS level available from the second base station according to an examination result from the control unit.

The QoS information that the base stations store in the QoS memory is classified according to the base stations.

The control unit is adapted to update in real time the QoS information stored in the QoS memory in response to a change in QoS information.

If a service level the same as the QoS information of the first base station is determined by the control unit to be not available, the QoS level determiner determines a QoS level available from the second base station.

According to another aspect of the invention, there is provided a method for monitoring QoS in a broadband wireless network, the method comprising the steps of: receiving and monitoring QoS information in real time from base stations having synchronized time information; if a wireless terminal in a service zone of a first base station requests to be handed off to a second base station, determining a QoS level according to the QoS information of the second base station; and transmitting the QoS level simultaneously to the first and second base stations.

In particular, if a service level the same as the QoS information of the first base station is determined to be not available for the wireless terminal, a QoS level available for the wireless terminal is determined.

The step of determining a QoS level according to the QoS information of the second base station may comprise the steps of: examining the QoS information of the second base station to determine whether or not a service level the same as the QoS information of the first base station is available; and determining a QoS level available from the second base station according to an examination result from the control unit.

If a service level the same as the QoS information of the first base station is determined not to be available, a QoS level available from the second base station is determined.

According to yet another aspect of the invention, there is provided a method for monitoring QoS in a broadband wireless network, the method comprising the steps of: receiving, by means of a first base station, a handoff request signal from a wireless terminal, and transmitting a handoff pre-notification signal simultaneously to a QoS monitoring server and a second base station; examining, by means of the QoS monitoring server, QoS information received in real time from the first and second base stations, determining a QoS level, and transmitting the QoS level simultaneously to the first and second base stations; and transmitting the QoS level from the first base station to the wireless terminal, handing the wireless terminal off to a cell zone of the second base station from a cell zone of the first base station, and providing service according to the QoS level to the wireless terminal by the second base station.

The QoS level may comprise a Global Header field, an MSS unique identifier field, a BS Estimated field, a QoS Estimated field, a Security field, and a CRC field.

The MSS unique identifier field may store an identifier unique to the wireless terminal (MSS) that is handed off to the service zone of the second base station.

The BS Estimated field may store bandwidth information for ensuring minimum packet data transmission.

The QoS Estimated field may store at least one of an Unsolicited Grant Service (UGS), a Real time Polling Service (rtPS), a Non-real time Polling Service (nrtPS), and a Best effort Service (BE) levels.

The Security field may store a code for the QoS level.

The CRC field may store information available for detecting an error occurring during the transmission of the QoS level.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating network connection in a wireless terminal handoff in a broadband wireless network;

FIG. 2 is a flowchart illustrating messages in a handoff process;

FIG. 3 is a block diagram illustrating network connection in a wireless terminal handoff in a broadband wireless network in accordance with the invention;

FIG. 4 is a block diagram illustrating the structure of a QoS monitoring server as shown in FIG. 3; and

FIG. 5 is a flowchart illustrating messages in a handoff process in accordance with the invention.

### DETAILED DESCRIPTION OF THE INVENTION

The following detailed description will present preferred embodiments of the invention in conjunction with the accompanying drawings. For reference, the same or similar reference signs will designate corresponding parts throughout several views. In the following detailed description, well-known functions or components will not be described in detail if they will unnecessarily obscure the understanding/concept of the invention.

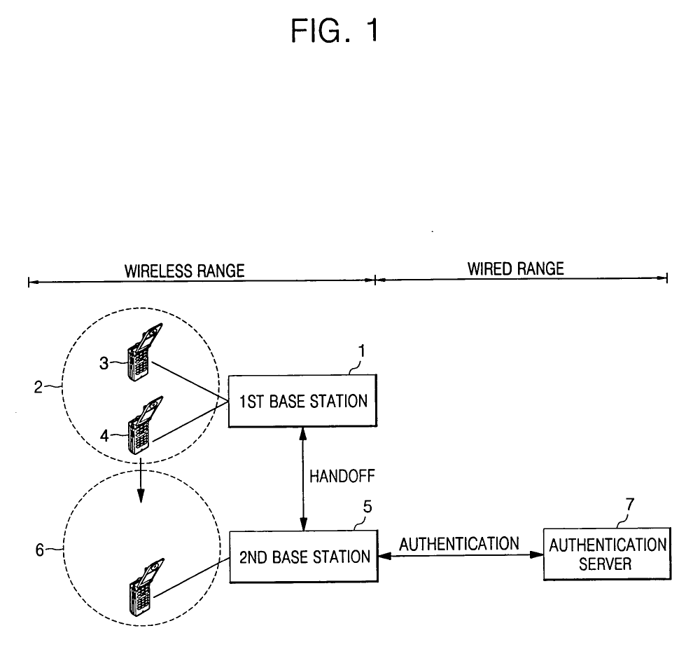

FIG. 1 is a block diagram illustrating network connection during a terminal handoff in a wideband wireless network. As seen therein, first and second base stations 1 and 5 provide first and second cells 2 and 6, respectively, as their service zones. While Mobile Subscriber Stations (MSS) or wireless terminals 3 and 4 are being serviced in the first cell 2, any of the wireless terminals 3 are 4 are handed off to the second cell 6. In this case, an Authentication and Service Authorization (ASA) server 7 executes authentication or examines whether or not the wireless terminals located in corresponding service zones are subscribed to corresponding base stations.

In the handoff process, the first base station 1 receives bandwidth information and QoS information from the wireless terminal to be handed off, and transmits the bandwidth and QoS information to the second base station 5 as a target base station. Then, the second base station 5, as a target base station, notifies the first base station 1 as to whether or not the QoS service in the first cell 2 can be ensured, using a prediction table as shown in Table 1 below.

TABLE 1

| Expected | |
|---|---|
| Service level | Remarks |
| 0 | No service possible for this MSS |
| 1 | Some services are available for one or several Service |
| | Flows authorized for the MSS |
| 2 | For each authorized Service Flow, MAC connection can be |
| | established with QoS specified by the Authorized |
| | QoSParamSet |

As reported in Table 1 above, service level “0” indicates that a wireless terminal or MSS to be handed off will not be serviced, and service level “1 ” indicates that a wireless terminal to be handed off will be serviced at a service level poorer than currently provided to the wireless terminal.

Service level “2” means that Medium Access Control (MAC) connection may be established with respective authenticated services, and service level “3” means that there are no expected service levels.

Then, the wireless terminal to be handed off under the control of the first base station 1 proceeds with a negotiation process with the second base station 5 as a target base station.

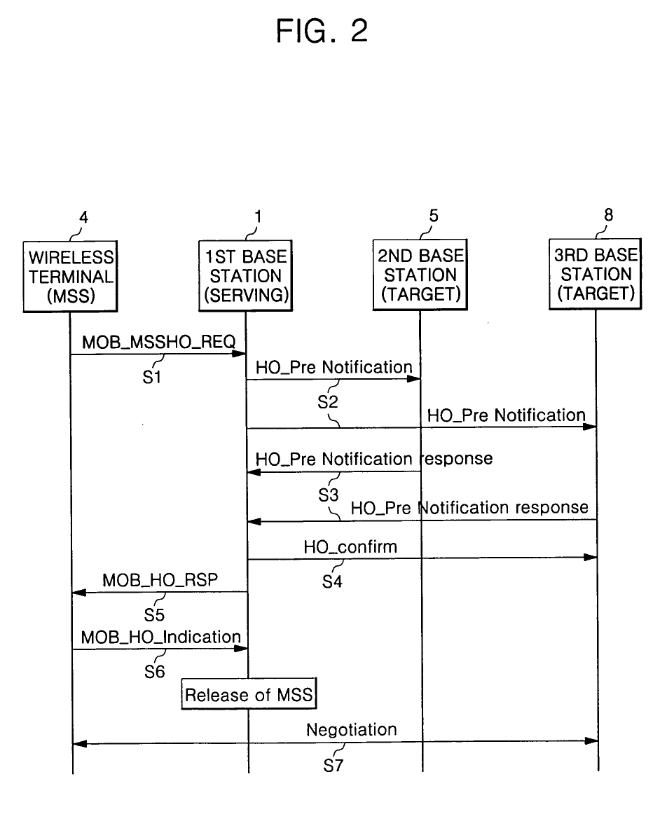

FIG. 2 is a flowchart illustrating messages in a handoff process.

As shown in FIG. 2, when a wireless terminal 4 sends a “MOB_MSSHO_REQ” message as a handoff request message to a first base station 1 in step S1, the first base station 1 transmits a “HO-Pre Notification” message as a preliminary handoff request signal to neighboring second and third base stations 5 and 8, respectively, as target base stations in step S2.

In response to the “HO-Pre Notification” message, each of the second and third base stations 5 and 8, respectively, transmits an “HO-Pre Notification Response” message to the first base station 1 in step S3. The “HO-Pre Notification response” message has level information corresponding to one of the QoS levels reported in Table above.

For example, when the second base station 5 transmits QoS level information “1 ” and the third base station 8 transmits QoS level information “2”, the QoS level information “1 ”indicates that “Some services are available for one or several service flows authorized for the MSS” and the QoS level information “2” indciates that “For each authorized Service Flow, MAC connection can be established with QoS specified by the Authorized QoSParamSet.” Then, the first base station 1 transmits an “HO_confirm” message as a handoff confirmation signal to the third base station in step S4.

After that, the first base station 1 transmits a “MOB_HO_RSP” message to the wireless terminal 4 as a response signal to the “MOB_MSSHO_REQ” message as a handoff request signal in step S5.

As a response signal to the “MOB_HO_RSP” message, the wireless terminal 4 transmits a “MOB_HO_Indication” message to the first base station 1 in step S6.

Then, the wireless terminal 4 is handed off from the first base station 1 to the third base station 8. That is, the wireless terminal 4 is released or disconnected from the first base station 1, but is connected to the third base station 8. In step S7, in order to be provided with new QoS from the third base station 8, the wireless terminal 4 negotiates with the third base station 8 for a QoS level.

Accordingly, as described above, when a specific wireless terminal is to be handed off from a current service cell to another adjacent cell, since a current servicing base station is only notified as to whether or not the QoS level will be ensured, the wireless terminal has to proceed with a negotiation process for a new QoS whenever it is to be handed off to another service cell. As a result, this extends the delay time for the wireless terminal to be provided with optimum QoS whenever it is to be handed off to another service cell. Furthermore, it is highly probable that the wireless terminal will be provided with basic QoS only when it moves rapidly.

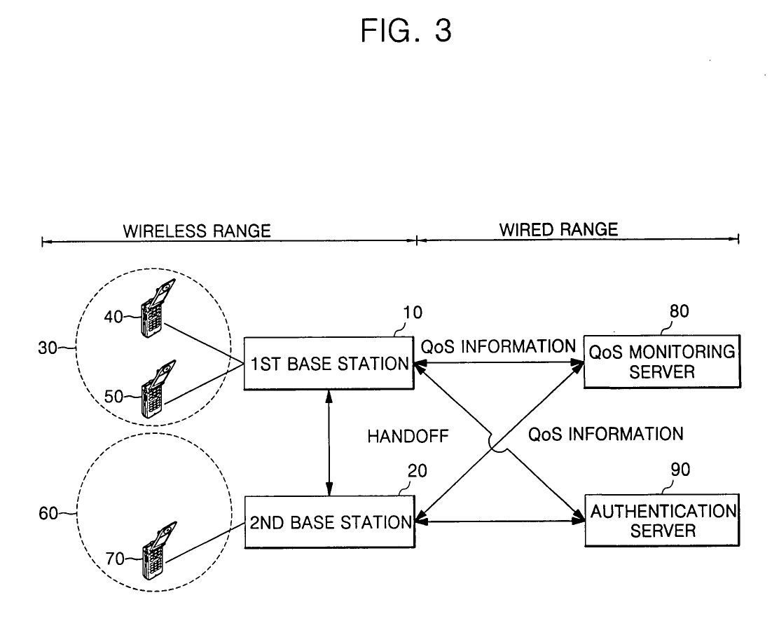

FIG. 3 is a block diagram illustrating network connection during a wireless terminal handoff in a broadband wireless network in accordance with the invention.

As shown in FIG. 3, a monitoring system includes first and second base stations 10 and 20, respectively, adapted to provide wireless communication service in the broadband wireless network, MSS or wireless terminals 40 and 50 located in a first cell 30 as a service zone of the first base station 10, a wireless terminal 70 located in a second cell 60 as a service zone of the second base station 20, a QoS monitoring server 80 adapted to monitor real time QoS information of the cells, which information is received from the first and second base stations 10 and 20, respectively, and an authentication server 90 adapted to examine whether or not the wireless terminals located in the service zones of the first and second base stations 10 and 20, respectively, are subscribed thereto.

The MSS or wireless terminals 40 and 50 located in the first cell 30 as the service zone of the first base station 10 are provided with service by the first base station 10, and the wireless terminal 70 located in the second cell 30 as the service zone of the second base station 10 is serviced by the second base station 20.

In this manner, the wireless terminals located in the service zones of the base stations are provided with available services of specific QoS level from the base stations. The services are classified into E-mail service, MP3 or dynamic image service, and FTP service for file transmission according to the QoS levels.

The first and second base stations 10 and 20, respectively, transmit QoS information of the cells in real time to the QoS monitoring server 80, while maintaining synchronization with the QoS monitoring server 80.

Also, whenever the QoS information is changed, the first and second base stations 10 and 20, respectively, transmit the changed QoS information to the QoS monitoring server 80.

The QoS monitoring server 80 receives the real time QoS information of the first and second base stations 10 and 20, respectively, so as to update the QoS information of the base stations 10 and 20, respectively.

In this way, the QoS monitoring server 80 can maintain centralized real time monitoring on the QoS information of the respective base station.

In addition, when one of the terminals in the service zone of the first base station 10 sends a signal requesting handoff to the second base station 20, handoff procedures are initialized. At the same time, the QoS monitoring server 80 receives a handoff request signal from the first base station 10.

Then, the QoS monitoring server 80 examines the QoS information of the second base station 20 to determine whether or not the wireless terminal to be handed off can be serviced at the same level as the QoS provided by the first base station 10.

If the wireless terminal to be handed off cannot be serviced by the second base station 20 at the same level as the QoS by the first base station 10, the QoS monitoring server selects a QoS level currently available from the second base station 20, and transmits selected QoS information simultaneously to the first and second base stations 10 and 20, respectively.

Accordingly, the wireless terminal is handed off from the service zone of the first base station 10 to the service zone of the second base station 20. That is, the wireless terminal is disconnected or released from the first base station 10, and is connected to the second base station 20.

In this event, the wireless terminal is serviced by the second base station 20 according to the QoS information received from the QoS monitoring server 80 without having to start QoS negotiations with the second base station 20.

As a result, this invention allows the wireless terminal to be continuously serviced according to optimum QoS information without delay time when the wireless terminal is handed off in the broadband wireless network.

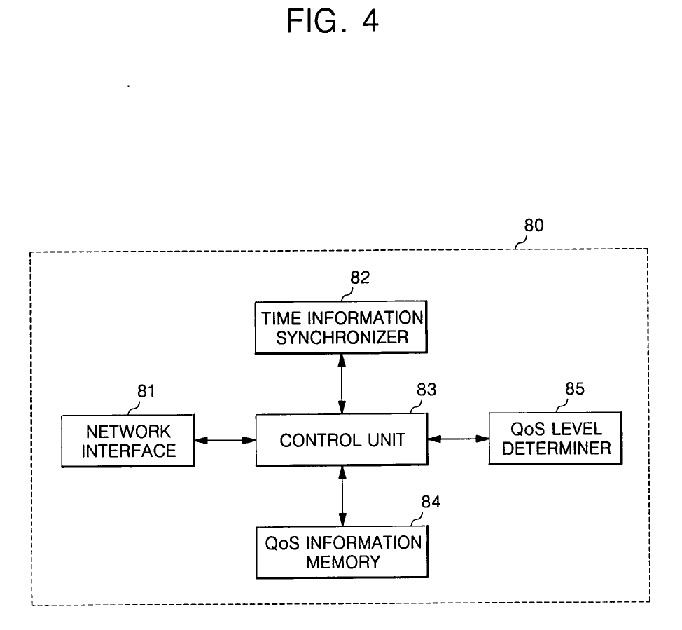

FIG. 4 is a block diagram illustrating the structure of the QoS monitoring server as shown in FIG. 3.

As shown in FIG. 4, the QoS monitoring server 80 of the invention includes a network interface 81, a time information synchronizer 82, a control unit 83, a QoS information memory 84, and a QoS level determiner 85.

The network interface 81 interfaces with base stations, receiving and transmitting information from/to the base stations.

The time information synchronizer 82 is connected to the base stations in a backbone network, and receives time information from the base stations so as to synchronize the time information therewith.

The control unit 83 receives QoS information from the base stations via the network interface 81 so as to store the QoS information in the QoS information memory 84.

In particular, when a servicing base station has transmitted a handoff request signal in response to a handoff request from a wireless terminal in its service zone, the control unit 83 monitors real time QoS information transmission between the servicing base station and a target base station to which the wireless terminal is to be handed off.

That is, the control unit 83 examines the QoS information of the target base station to determine whether or not the wireless terminal to be handed off can be serviced by the target base station at the same level as the QoS provided by the servicing base station. According to the result of that determination, control unit 83 requests the QoS level determiner 85 to determine a QoS level available from the target base station.

The QoS information memory 84 discriminates and stores the QoS information of the base stations received via the network interface 81 according to the base stations.

According to the result of determination by the control unit 83, the QoS level determiner 85 determines a QoS level at which the target base station will service the wireless terminal to be handed off from the servicing base station thereto.

That is, if the wireless terminal to be handed off cannot be serviced by the target base station at the same level as the QoS provided by the servicing base station, the QoS level determiner 85 determines a QoS level available from the current target base station and notifies the control unit 83 of the determined QoS level.

The control unit 83 then transmits the new QoS information determined by the QoS level determiner 85 simultaneously to the servicing base station and the target base station via the network interface 81.

Accordingly, when handed off from the servicing base station to the target base station, the wireless terminal receives the new QoS information from the servicing base station, and is released therefrom before connecting to the target base station, so that the wireless terminal can be continuously serviced at the optimum QoS without having to start additional QoS negotiations with the target base station.

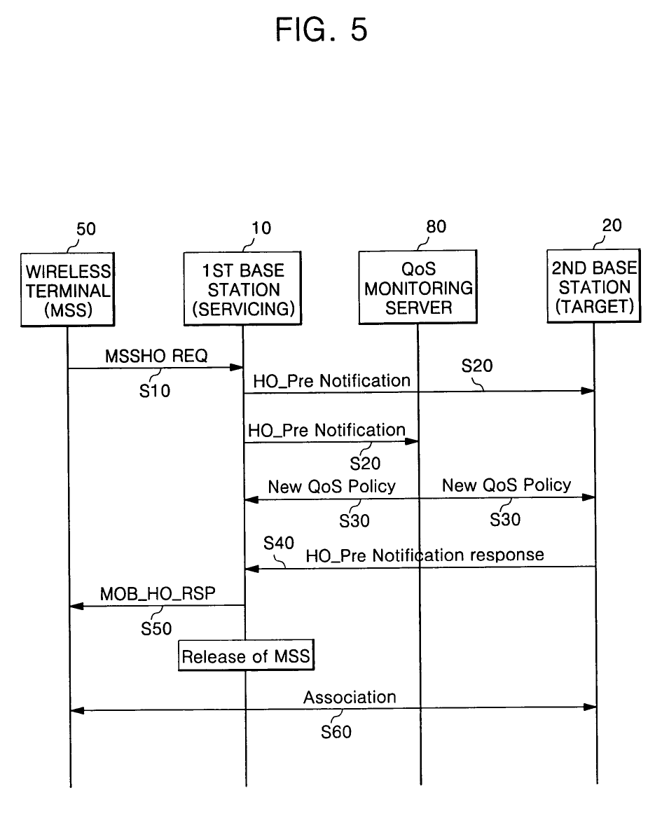

FIG. 5 is a flowchart illustrating messages in a handoff process in accordance with the invention.

As shown in FIG. 5, when the wireless terminal 50 transmits an “MSSHO REQ” message as a handoff request signal to the first base station 10 that is the current servicing base station of the wireless terminal 50 in step S10, the first base station 10 transmits an “HO_Pre Notification” message simultaneously to the QoS monitoring server 80 and the second base station 20 as a neighboring target station in step S20.

The “HO_Pre Notification” message has a field structure as shown in Table 2 below.

TABLE 2

| Field | Size | Remarks |
|---|---|---|
| Global Header | 152-bit | |
| For(j=0; j<Num Records; | | |
| j++) { | | |
| MSS unique identifier | 48-bit | 48-bit unique identifier used by MSS(as provided by the |
| | | MSS or by the I-am-host-of message) |
| Estimated Time to HO | 16-bit | In milliseconds, relative to the time stamp. A value of 0 |
| | | indicates that the estimated time is unknown |
| Required BW | 8-bit | Bandwidth which is required by MSS(to guarantee |
| | | minimum packet data transmission) |
| Required QoS | 8-bit | name of Service Class representing Authorized |
| | | QoSparamSet |
| } | | |
| Security field | TBD | A means to authenticate this message |
| CRC field | 32-bit | IEEE CRE-32 |

As shown in Table 2 above, the “HO_Pre Notification” message has a Global Header field, an MSS unique identifier field, an Estimated Time to HO field, a Required BW field, a Required QoS field, a Security field, and a CRS field.

MSS unique identifier has a 48 bit size, and stores an identifier unique to the wireless terminal or MSS to be handed off. The identifier is provided by the wireless terminal or from an I-am-host-of message.

Estimated Time to HO field has a 16 bit size, and stores an estimated time for the wireless terminal to be handed off. Time unit is in milliseconds, and relative with respect to a time stamp. In particular, an estimated time value of 0 up to handoff indicates that estimated time is not acknowledgeable.

Required BW field has an 8 bit size, and stores a bandwidth required by the wireless terminal or MSS to be handed off to ensure minimum packet data transmission.

Required QoS field has an 8 bit size, and stores the name of a service class designating authenticated QoSparamSet.

The security field is To Be Determined (TBD), and stores information associated with the encryption of the “HO_Pre Notification” message.

CRC field has a 32 bit size, and stores information available for detecting any error that might occur during message transmission.

In step S30, the QoS monitoring server 80 transmits a new QoS policy simultaneously to the first and second base stations 10 and 20, respectively. The information for the new QoS policy has a field structure as shown in Table 3 below.

TABLE 3

| Field | Size | Remarks |
|---|---|---|
| Global Header | 152-bit | |
| For(j=0; j<Num Records; | | |
| j++{ | | |
| MSS unique identifier 48- | 48-bit | 48-bit unique identifier used by MSS(as provided by the |
| bit | | MSS or by the I-am-host-of message) |
| BW Estimated | 8-bit | Bandwidth which is provided by BS (to guarantee |
| | | minimum packet data transmission) TBD how to set this |
| | | field. |
| QoS Estimated | 8-bit | Quality of Service level |
| | | Unsolicited Frant Service(UGS) |
| | | Real-time Polling Service(rtPS) |
| | | Non real time Polling Service(nrtPS) |
| | | Best effort |
| } | | |
| Security | TBD | A means to authenticate this message |
| CRC field | 32-bit | IEEE CRE-32 |

As shown in Table 3 above, the information for the new QoS policy has a Global Header field, an MSS unique identifier field, a BS Estimated field, a QoS Estimated field, a Security field, and a CRC field.

MSS unique identifier field has a 48 bit size, and stores an identifier unique to the wireless terminal (MSS) to be handed off. The identifier is provided by the wireless terminal or from an I-am-host-of message.

BS Estimated field has an 8 bit size, and stores a bandwidth provided by a base station to ensure minimum packet data transmission. In particular, the establishment of this field is To Be Determined (TBD).

QoS Estimated field has an 8 bit size, and has a service level selected from four service levels discussed below.

That is, the estimated QoS level is classified into Unsolicited Grant Service (UGS) corresponding to E-mail service, Real time Polling Service (rtPS) corresponding to MP3 or dynamic image service level, Non-real time Polling Service (nrtPS) corresponding to FTP service level, and Best Effort Service corresponding to optimum service level.

The Security field is To Be Determined (TBD), and stores information associated with the encryption of the QoS message.

CRC field has a 32 bit size, and stores information available for the detection of an error that might occur during message transmission.

In step S40, the second base station 20 transmits an “HO_Pre Notification response” message to the first base station 10 in response to the “HO_Pre Notification” from the first base station 10. The “HO_Pre Notification response” has a field structure as shown in Table 4 below.

TABLE 4

| Field | Size | Remarks |
|---|---|---|
| Global Header | 152-bit | |
| For(j=0; j<Num Records; | | |
| j++) { | | |
| MSS unique identifier | 48-bit | 48-bit unique identifier used |
| | | by MSS(as provided by the |
| | | MSS or by the I-am-host-of message) |
| } | | |
| Security | TBD | A means to authenticate this message |
| CRC field | 32-bit | IEEE CRE-32 |

As shown in Table 4 above, the “HO__Pre Notification response” has a Global Header field, an MSS unique identifier field, a Security field, and a CRC field.

The MSS unique identifier field has a 48 bit size, and stores an identifier unique to a wireless terminal or MSS to be handed off. The identifier is provided by the wireless terminal or via an I-am-host-of message.

The security field is To Be Determined (TBD), and stores information associated with the encryption of the “HO_Pre Notification response” message.

The CRC field has a 32 bit size, and stores information available for the detection of an error that might occur during message transmission.

In step S50, the first base station 10 transmits a “MOB_HO_RSP” message to the wireless terminal 50 in response to the “MSSHO REQ” message as a handoff request signal from the wireless terminal 50.

Then, the first base station 10 releases the wireless terminal 50 of the service, so that the wireless terminal 50 is handed off to the cell zone of the second base station 20 so as to be serviced thereby without time delay in step S60.

As described hereinbefore, the system and the method for monitoring QoS in a broadband wireless network of the present invention can monitor QoS information of base stations, and previously designate wireless terminals with QoS levels in the broadband wireless network in order to minimize QoS authentication procedures, thereby ensuring optimum QoS without time delay when a wireless terminal is handed off.

While the present invention has been shown and described in connection with the preferred embodiments, it will be apparent to those skilled in the art that modifications and variations can be made without departing from the spirit and scope of the invention as defined by the appended claims.

What is claimed is:

1. A system for monitoring Quality of Service (QoS) in a broadband wireless network, including a monitoring server which comprises:
means for receiving and monitoring QoS information in real time from base stations having synchronized time information;
determining means, responsive to a wireless terminal in a service zone of a first base station requesting to be handed off to a second base station, for determining a QoS level according to a QoS information of the second base station; and
means for transmitting the QoS level simultaneously to the first and second base stations.

2. The system of claim 1, wherein the monitoring server examines the QoS information of the second base station, and if a service level the same as a QoS information of the first base station is determined to be not available for the wireless terminal, the monitoring server determines a QoS level available for the wireless terminal.

3. The system of claim 1, wherein the wireless terminal is provided with a service according to the QoS level determined by the monitoring server when handed off to a cell zone of the second base station.

4. The system of claim 1, wherein the monitoring server further comprises:
a QoS memory for storing the QoS information received in real time from the base stations having synchronized time information;
a control unit for examining the QoS information of the second base station stored in the QoS memory in response to a handoff request from the first base station so as to determine whether or not a service level the same as QoS information of the first base station is available; and
a QoS level determiner for determining a QoS level available from the second base station according to a result of the determination by the control unit.

5. The system of claim 4, wherein the QoS information that the base stations store in the QoS memory is classified according to the base stations.

6. The system of claim 4, wherein the control unit is adapted to update in real time the QoS information stored in the QoS memory in response to a change in QoS information.

7. The system of claim 4, wherein, if a service level the same as the QoS information of the first base station is determined by the control unit to be not available, the QoS level determiner determines a QoS level available from the second base station.

8. A system for monitoring Quality of Service (QoS) in a broadband wireless network, comprising:
a QoS memory for storing QoS information received in real time from base stations having synchronized time information;
a control unit responsive to a wireless terminal in a service zone of a first base station requesting to be handed off to a second base station, for examining QoS information of the second base station stored in the QoS memory to determine whether a service level the same as QoS information of a first base station is available from the second base station; and
a QoS level determiner for determining a QoS level in the second base station according to a result of the determination by the control unit.

9. The system of claim 8, wherein the QoS information of the base stations stored in the QoS memory is classified according to the base stations.

10. The system of claim 8, wherein the control unit is adapted to update in real time QoS information stored in the QoS memory in response to a change in QoS information.

11. The system of claim 8, wherein, if a service level the same as the QoS information of the first base station is determined by the control unit to be not available, the QoS level determiner determines a QoS level available from the second base station.

12. A method for monitoring Quality of Service (QoS) in a broadband wireless network, the method comprising the steps of:
(a) receiving and monitoring QoS information in real time from base stations having synchronized time information;
(b) when a wireless terminal in a service zone of a first base station requests to be handed off to a second base station, determining a QoS level according to QoS information of the second base station; and
(c) transmitting the QoS level simultaneously to the first and second base stations.

13. The method of claim 12, wherein step (b) comprises examining the QoS information of the second base station and, when a service level the same as QoS information of the first base station is determined to be not available for the wireless terminal, determining a QoS level available for the wireless terminal.

14. The method of claim 12, wherein step (b) comprises the sub-steps of:
(b1) examining the QoS information of the second base station to determine whether the service level the same as the QoS information of the first base station is available; and
(b2) determining a QoS level available from the second base station according to a result of the determination in sub-step (b1).

15. The method of claim 14, wherein if the service level the same as QoS information of the first base station is determined to be not available, step (b2) comprises determining a QoS level available from the second base station.

16. A method for monitoring Quality of Service (QoS) in a broadband wireless network, the method comprising steps of:
(a) receiving, at a first base station, a handoff request signal from a wireless terminal, and transmitting a handoff pre-notification signal simultaneously to a QoS monitoring server and a second base station;
(b) examining, at the QoS monitoring server, QoS information received in real time from the first and second base stations, determining a QoS level, and transmitting the QoS level simultaneously to the first and second base stations; and
(c) transmitting the QoS level from the first base station to the wireless terminal, handing the wireless terminal off to a cell zone of the second base station from a cell zone of the first base station, and providing a service according to the QoS level provided to the wireless terminal by the second base station.

17. The method of claim 16, wherein the QoS level comprises a Global Header field, an MSS unique identifier field, a BS Estimated field, a QoS Estimated field, a Security field, and a CRC field.

18. The method of claim 17, wherein the MSS unique identifier field stores an identifier unique to the wireless terminal (MSS) that is handed off to the service zone of the second base station.

19. The method of claim 17, wherein the BS Estimated field stores bandwidth information for ensuring minimum packet data transmission.

20. The method of claim 17, wherein the QoS Estimated field stores at least one of an Unsolicited Grant Service (UGS), a Real time Polling Service (rtPS), a Non-real time Polling Service (nrtPS), and Best Effort Service (BE) levels.

21. The method of claim 17, wherein the Security field stores a code for the QoS level.

22. The method of claim 17, wherein the CRC field stores information available for detecting an error occurring during the transmission of the QoS level.
